(19) United States
(12) Patent Application Publication
(10) Pub. No.: US 2008/0313084 A1
(43) Pub. Date: Dec. 18, 2008

(54) Digital Content Royalty Management System and Method

(76) Inventor: David E. Socolofsky, Humble, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 12/140,815

(22) Filed: Jun. 17, 2008

Related U.S. Application Data
(60) Provisional application No. 60/936,159, filed on Jun. 18, 2007.

(51) Int. Cl. G06Q 10/00; H04L 9/32; G06Q 30/00

(52) U.S. Cl. 705/52; 705/51; 705/30

(57) ABSTRACT

A system and method manages the royalties for owners of digital content when processed or output by a user. A control module on a user device decodes information in a watermark embedded in a digital file and restricts output of the digital file based on the decoded information. The control module obtains charge-back information from the user and sends it to a remote managing account payment module for verification. With the information verified, the account payment module sends access information to the user device that permits the digital file to be output. After output, the control module sends information about the output to the account payment module, which debits funds from the user's account and credits the digital file owner's account based on the output of the digital file by the user.

### CROSS-REFERENCE TO RELATED APPLICATIONS

This is a non-provisional of U.S. Provisional Application Ser. No. 60/936,159, filed 18 Jun. 2007, which is incorporated herein by reference and to which priority is claimed.

### BACKGROUND

Copyright owners earn royalties when they allow others to reproduce, distribute, display, or perform other specific activities related to their copyrighted works. As expected, copyright owners have a strong interest in protecting their copyrighted works, preventing their illegitimate distribution, reproduction and the like, and receiving proper royalties for legitimate use. Unfortunately, the electronic age significantly challenges how copyright owners can protect their copyrighted works because end-users can use available technologies to infringe the owner's rights with principally little hindrance.

For this reason, Digital Rights Management (DRM) and other technologies have been developed to protect digital media from illegitimate copying, distribution, etc. For example, audio files on Compact Discs can use DRM so software on a computer can prevent copying of the protected music. Microsoft's Protected Media Path runs in a protected environment that enables Windows Vista to handle protected content and prevents DRM-restricted media from being played when untrusted code is running. DRM is also used to restrict use of music purchased via the Internet. For example, consumers can purchase music from the itunes Store, which uses Apple's FairPlay DRM system. Unfortunately, the various formats and software for DRM used in the industry are not compatible with one another, which hinders wide distribution and portability of digital media. Due to these and other difficulties associated with DRM, use of DRM has been declining recently.

Other technologies to protect digital media use subscriptions. For example, Internet music sources, such as Napster and Rhapsody, offer a subscription-based service that allows a user to listen to music while subscribed to the service. The music, however, may not be playable on any given device and may be rendered unusable if the user's subscription is not current or expires. In addition, to copy the music to a CD, the user may need to use the source's software to copy it and may need to actually purchase the music from the service apart from already paying for a subscription.

In other techniques to protect digital media, digital watermarks and metadata can be used with the digital media to inhibit illegitimate copying and distribution. Digital watermarks use data steganographically embedded within the data of a digital file. The watermark can record the copyright owner, distributor, and distribution chain of digital media and can also identify the purchaser. Similar to the watermark, metadata can be included in purchased files to record information such as the purchaser's name, account information, or email address. As an example, Apple's itunes Store embeds this type of information in media purchased by a consumer. Because the watermarks and metadata can include such identifying information with the file, end-users may be dissuaded from illegitimately copying and distributing the file.

In still other techniques, Advanced Access Content System (AACS) is developing a specification for managing content stored on optical media for use with PCs and CE devices. Digital Video Broadcasting—Content Protection and Copy Management (DVB-CPCM) controls the boundaries in which an end-user can use and distribute digital content by defining an authorized domain of DVB-CPCM compliant devices that are owned, rented, or controlled by the end-user.

What copyright owners need is a system that provides for the broadest, most ubiquitous form of content distribution that ensures compensation to the copyright owner, ease of use to the customer, and reduces the risk of illegal use. Even with existing techniques, what is needed is a way that can be widely implemented for copyright owners to protect their digital media and to collect royalties for use of the digital media by end-users.

### BRIEF DESCRIPTION OF THE DRAWINGS

FIG. 1 illustrates one embodiment of a digital content royalty management system according to certain teachings of the present disclosure.

FIG. 2 illustrates a process for digital content royalty management with the system of FIG. 1.

FIG. 3 shows an example of a payment interface for obtaining charge-back information from a user.

FIG. 4 diagrammatically shows information that can be contained in encrypted data associated with a digital file.

FIG. 5 illustrates another embodiment of a digital content royalty management system.

### DETAILED DESCRIPTION

### A. DIGITAL CONTENT ROYALTY MANAGEMENT SYSTEM

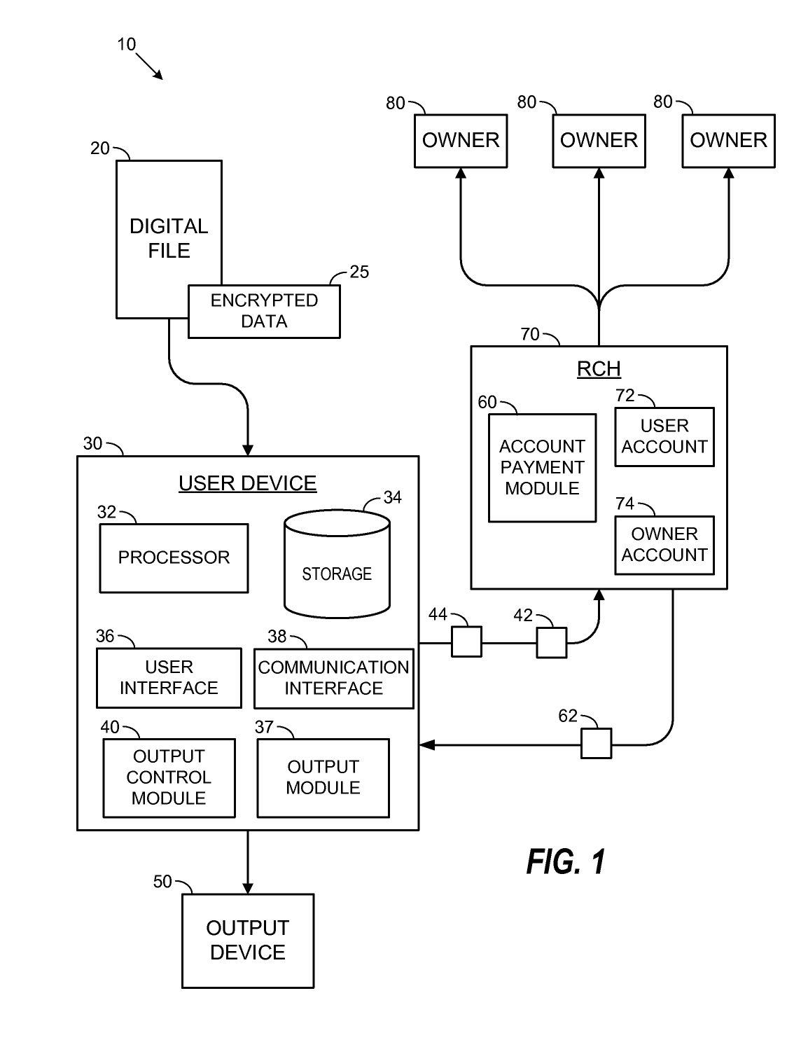

A digital content royalty management system 10 illustrated in FIG. 1 controls and tracks use or output (e.g., playback, printing, reproduction, etc.) of digital content (e.g., a digital file) 20 and relates that tracked output to royalty payments to the copyright owner 80 of the digital file 20. In general, the digital file 20 can be a song, video, text document, image, or the like. As shown, an end-user has a user device 30 and possibly an external output device 50 to process and output the digital file 20 (e.g., to play the song or video, display the text file, print the image, copy the digital file 20, etc.). As will be evident, the user device 30 can have a processor 32, storage 34, a user interface 36, an output module 37, a communication interface 38, and any other conventional components not detailed herein.

To control and track output of the digital file 20, the system 10 uses encrypted data 25 associated with the digital file 20 and uses an output control module 40 running on the user device 30. In general, the output control module 40 handles the encrypted data 25 and acts as a gateway for outputting (using) the digital file 20 and for subsequently tracking the file's output (use). To handle any royalties for the file's output, the system 10 uses an account payment module 60 at a remote manager or royalty clearinghouse 70. This account payment module 60 receives information about the file's output from the output control module 40 and reports use of the digital file 20 to the copyright owner 80 and makes corresponding royalty payments to the owner 80 from the user account 72.

### B. DIGITAL CONTENT ROYALTY MANAGEMENT PROCESS

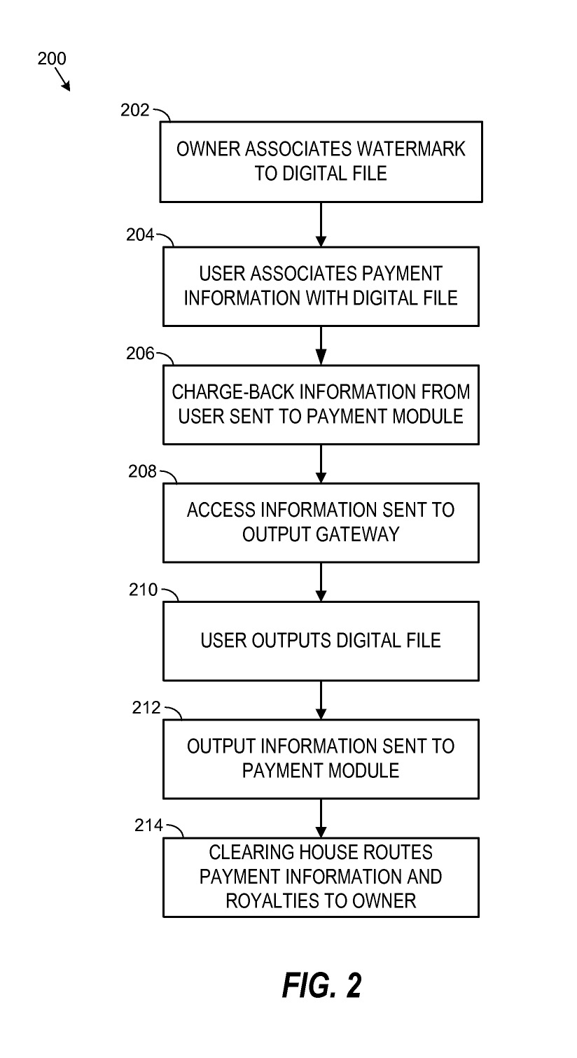

Given the brief overview above, operation of the system 10 will be better understood with concurrent reference to FIG. 2, which shows a process 200 for digital content royalty management using the system 10 of FIG. 1. Initially, a copyright owner 80 associates the encrypted data 25 with the digital file 20 having their copyrighted work fixed thereon (Block 202). The encrypted data 25 can take any form available in the art, such as a watermark, metadata, or the like. As a watermark, for example, the encrypted data 25 can be steganographically embedded within the data of the digital file 20 using techniques known in the art and can include information identifying the copyright owner 80, restricting output of the file 20 by defining particular usage controls and rates, and performing other purposes disclosed herein. As described in more detail later, the encrypted data 25 can identify permitted uses (e.g., output) and any royalty associated with such use in the form of usage controls and usage rates. Other uses could be prohibited. In configuring the encrypted data 25, the owner 80 could alternately set only prohibited uses and could allow all other uses at a set royalty. The ability to set uses and royalties are limited only by the capabilities of the encrypted data 25's space and flexibility.

Once the encrypted data 25 has been associated with the file 20, the owner 80 can then freely distribute the file 20 to end-users without requiring a purchase or a subscription. Accordingly, the present invention provides for free copying, loaning, and distribution of the new encrypted digital file 20. This free distribution provides for broad dissemination of the copyright and material to end-users. users. In other words, neither the end-user nor the end-user's device (e.g., computer, music player, etc.) needs to have any special rights or authorizations to access, download, obtain, or otherwise receive the digital file 20 from a source (i.e., server, other device, compact disc, etc.). Moreover, the end-user's device does not need to be a specifically designated device enabled to receive and process the digital file 20 from a source. In essence, then, the free distribution of the digital file 20 provided herein permits a broad, ubiquitous form of distributing the digital file 20 and may involve unrestricted distribution.

At some point after distribution of the file 20, an end-user may attempt to output (i.e., use) the file 20 (e.g., play the song, print the image, open the document, etc). Before the file 20 can be used, however, the output control module 40 decodes the encrypted data 25 that controls or restricts the file's output, and based on that control, the output control module 40 requires the end-user to meet an accounting requirement used to account for the end-user's immediate and future use of the digital file 20. For example, the output control module 40 requires the end-user to associate payment or charge-back information with the digital file 20 to satisfy the accounting requirement restricting outright use of the digital file 20 (Block 204). This payment or charge-back information can include an account number, a credit card number, and other similar financial information indicating how the end-user will pay for output of the file 20 that the end-user wishes to perform.

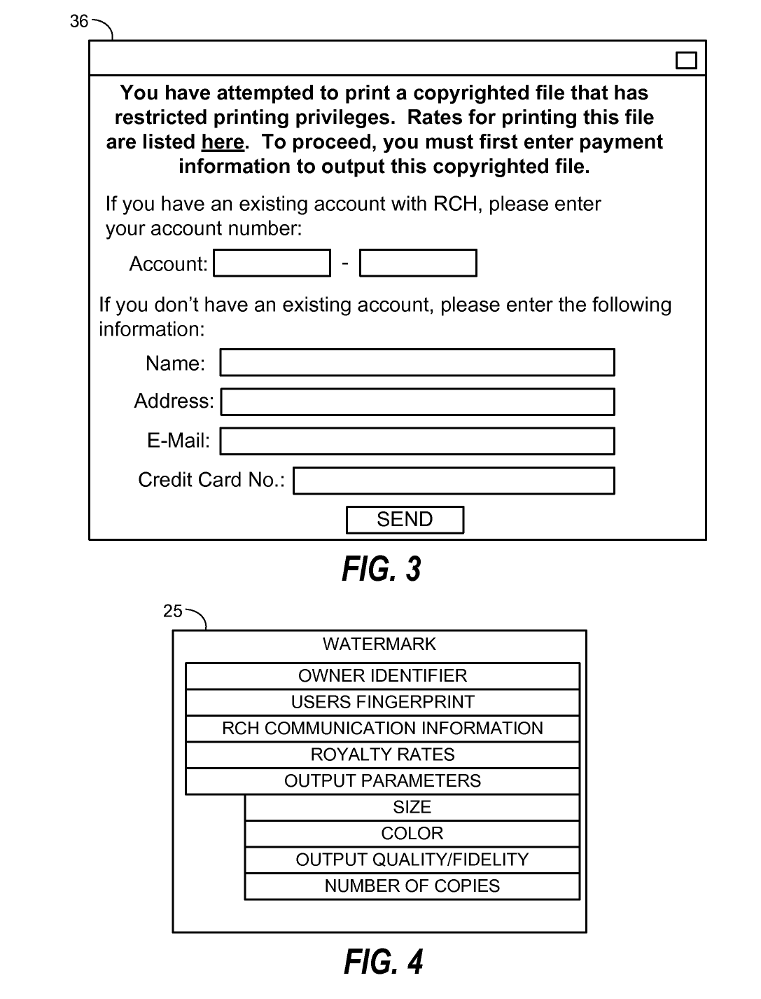

To obtain the charge-back information, the output control module 40 can access a user interface in which the end-user enters an account number, a credit card number, contact information, bank information, or other types of charge-back information. As an example, FIG. 3 shows a user interface 36 that can be displayed to the end-user to obtain the charge-back information. When the end-user attempts to output the file 20 for the first time, the output control module 40 can collect the charge-back information via such a user interface (36; FIG. 3) and can then store the information in storage 34 on the user device 30 for later retrieval. Then, when the end-user seeks to output the file 20 again at a later time, the output control module 40 can directly access the entered charge-back information in storage 34 with or without the need to interface with the end-user.

After obtaining the charge-back information in satisfaction of the accounting requirement, the output control module 40 sends the end-user's charge-back information in an access request 42 to the account payment module 60 at the clearinghouse 70 using the device's communication interface 38, and the account payment module 60 then validates the charge-back information in the request 42 (Block 206). In validating the information, the account payment module 60 can determine that the end-user's charge-back information is valid. In addition, the module 60 can establish a user account 72 (or access a pre-existing user account) and can associate the end-user's charge-back information in the request 42 with the account 72, along with other information about the digital file 20, the owner 80, the end-user, etc. for tracking purposes. Once established, the user's account 72 can be maintained at the clearinghouse 70 for handling subsequent output of the digital file 20 by the end-user, although the user's account 72 can be used for only a one-time transaction and may be deleted from the remote module 60 thereafter.

After verifying the charge-back information in the request 42, the account payment module 60 then returns a validation 62 to the output control module 40 via the device's communication interface 38 (Block 208). The received validation 62 indicates that the charge-back information has satisfied the accounting requirement that has caused the output control module 40 to restrict outright use of the digital file 20.

Based on this received validation 62, the output control module 40 “unlocks” the restricted output of the digital file 20 so the user device 30 can then output the digital file 20 with the output device 50 (Block 210). As disclosed herein, unlocking the files 20 can take many forms. To unlock the file 20, for example, the output control module 40 may use information (e.g., a key or code) contained in the validation 62 so that the user device 30 can output the file 20. In another example to unlock the file 20, the output control module 40 enabled by the validation 62 and acting as a gateway may allow software running on the user device 30 to access and process the file 20 and send the processed file 20 to either an output module 37 on the user device 30 or to the separate output device 50 for output (e.g., make prints or copies of image or text files, play back audio or video files, etc.). In addition to allowing output, the output control module 40 can control details of that output based on defined parameters, such as color balance, size, print quality, sampling rate, etc., embedded in the encrypted data 25 by decoding the data 25 and determining usage controls contained in the data 25, as described in more detail below.

Once the file 20 has been output, the output control module 40 records usage information describing or indicating the output or use of the file 20 and stores this usage information in the user device's storage 34. For example, if the digital file 20 is an image, the output control module 40 can track the resolution, number and sizes of prints made of the image by the end-user. If the digital file 20 is a song or movie, for example, the module 40 can track the number of times the end-user has played the song or movie. At some point (e.g., when output of the file 20 is complete or at some other interval), the output control module 40 sends the usage information 44 to the account payment module 60 using the device's communication interface 38 (Block 212).

The storage 34 for the usage information on the device 30 is preferably secure, as are the communications between the output control module 40 and the account payment module 60. Securing these features can use techniques known in the art so that particular details are not provided here. In addition, this usage information 44 when sent to the account payment module 60 can include information related to the output of only one file 20 or many files 20 depending on the implementation.

The account payment module 60 receives the usage information 44 from the output control module 40, matches the usage information 44 with the user's account 72 and the owner's account 74, and then updates the accounts 72 and 74 based on the usage. The rates for outputting or otherwise using the files could be in any given form, including but not limited to, points, credits, hits, money, etc. If the usage rates have a monetary form, then the module 60 would debit funds from the user's account 72 for the appropriate amount of money to cover the royalties for the reported output of the file 20 by the end-user and would credit funds to the copyright owner's account 74 in the amount of royalties collected from the end-user (Block 214). The module 60 could also forward payment information to the copyright owner 80

Although the above process 200 describes communicating the charge-back information in the request 42 and the usage information 44 in separate communications, the output control module 40 can send information about both the output and how to pay for that output in a single communication to the account payment module 60. In turn, the validation 62 can be returned to allow for the output of the file 20, while the account payment module 60 concurrently handles the royalty payments with the accounts 72 and 74 at the clearinghouse 70.

After outputting the file 20, the end-user may seek to output the digital file 20 again at a later time. If so, the output control module 40 can directly permit output of the file 20 without interfacing with the end-user or the account payment module 60 while still recording the usage information 44 for sending to the account payment module 60 later. In this situation, the output control module 40 may simply verify that charge-back information has already been obtained and associated with the digital file 20 in satisfaction of the accounting requirement restricting use of the digital file 20. Based on this pre-defined payment arrangement indicated by a previously received validation 62, the module 40 may allow output of the file 20 as long as the usage information for the output is stored for later submission to the account payment module 60.

Alternatively, each time the end-user seeks to output the file 20, the output control module 40 may request charge-back information from the end-user to be able to output of the file 20 so that an entirely new round of request and validation is performed between the modules 40 and 60. Repeated interfacing with the end-user each time, however, may be suitable for certain types of output (such as printing photographs) but may not be desirable for other types (such as playing a song). Accordingly, in yet another alternative, each time the end-user seeks to output the file 20, the output control module 40 accesses the end-user's charge-back information already in storage 34 and seamlessly sends the charge-back information and request 42 to the account payment module 60, receives the validation 62 when the charge-back information in the request 42 is verified, and unlocks the file 20 with the output control module 40 for output without requiring direct input from the end-user.

Likewise, depending on the requirements set by the copyright owner 80 in the encrypted data 25, the user device 30 may not need to communicate with the account payment module 60 for each use and may not need to be in communication with the account payment module 60 at the time of use. In addition, the user device 30 may not even need to be capable of communicating with the account payment module 60 and may instead rely on another device (e.g., a computer with an Internet connection) to achieve the communication. In general, the end-user may only need to acknowledge the obligation to pay the royalty by providing charge-back information to satisfy the accounting requirement, at which point the output control module 40 could permit use of the file 20 and could report that use in the module 40's next contact with the account payment module 60. For example, the user interface 36 can be used by the output control module 40 to obtain the charge-back information (i.e., get a confirmation or commitment from the end-user to pay the royalty), which can be stored in a secured area of storage 34 that can only be accessed by the output control module 40. This stored commitment could then permit use of the file 20 without the module 40 needing to actually contact the account payment module 60 at the time of use.

### C. FORMS OF ENCRYPTED DATA

As noted above, the encrypted data 25 can include information identifying the copyright owner 80 and the end-user and can define certain parameters related to the use (output) of the associated file 20. As also noted above, the variations of information that can be included in the encrypted data 25 are limited only by allotted storage space and the flexibility of the output control module 40 to use such data.

FIG. 4 shows some exemplary information that may be contained in the encrypted data 25. As shown, the encrypted data 25 can be a watermark and can include a unique identifier to identify the digital file 20 as belonging to a particular owner 80. In addition, the encrypted data 25 can have a digital fingerprint with the end-user's identity, account number, or the like, which can be used by the account payment module 60 to identify a particular end-user, user account, user device, or other item. In addition, should the end-user illegitimately output the file 20 (e.g., the end-user makes illegitimate copies of the file), the fingerprint can identify the end-user and may restrict or track such illegitimate output.

Use of the fingerprint, however, preferably encourages portability of the digital file 20 by allowing free distribution, copying, sharing, and forwarding of the digital file 20 while still accounting for its controlled use. Therefore, the disclosed system 10 can use the fingerprint to recognize when the digital file 20 is being used by a different device than the particular device used to unlock the file 20 by the end-user. For example, an end-user may provide charge-back information to pay royalties for playing the digital file 20 on the user's mp3 player, which would then be tracked in the fingerprint using a serial number, machine ID, or other common identifier used in the art. When that digital file 20 with the fingerprint is subsequently moved or copied to a different device (either belonging to the same end-user or someone else), the identifier in the fingerprint would indicate that the file 20 has been moved or copied somewhere other than the device that was covered by the previous charge-back arrangement. As a result, the digital file 20 would essentially be locked with respect to the new device so the file 20 could not be used on the new device until the accounting requirement is satisfied for that new device.

As noted above, the output control module 40 sends information to the account payment module 60 to obtain or report access to the file 20 and to track the output of the file 20. Therefore, it may be necessary to associate the digital file 20 with a particular clearinghouse 70 or other remote manager responsible for tracking and managing royalties associated with the file 20. Accordingly, the encrypted data 25 as shown in FIG. 4 can include communication information for the output control module 40 to connect to a royalty clearinghouse (RCH) or other remote manager. In one example, this communication information may be in the form of a network connection (e.g., a secure Universal Resource Location (URL) connection or other Internet connection) that the user's device 30 can use when communicating with a server of the clearinghouse 70 via the communication interface 38.

The encrypted data 25 can further specify royalty rates (also referred to herein as usage rates) for specific forms of output (use) of the digital file 20. These rates can be disclosed to the end-user and can be used when forwarding royalty payments to the original owner 80 based on the end-user's output of the digital file 20. The encrypted data 25 can further specify output parameters (also referred to herein as usage controls) specifically allowed or prohibited by the copyright owner 80. A number of parameters may specify allowed or disallowed size, color, quality, number of reproductions, duration of time allowed for output, and other details to control the output of the digital file 20, as discussed in examples below. The user interface 36 can be used by the output control module 40 to communicate with the end-user to set the user's selection as to output parameter or format if appropriate. Otherwise, the output control module 40 can obtain the selection of one or more of the usage controls based on interaction with the rendering or other software using (outputting, playing, displaying, etc.) the digital file 20.

If the digital file 20 is an image having a low resolution, for example, output parameters specified in the encrypted data 25 may only allow printing up to a certain size or quality so that the encrypted data 25 can limit reproduction of the image to only the specified output size or quality. In addition, the encrypted data 25 can also have output parameters that specify the number of times the digital file 20 may be output, copied, played, read, accessed, printed, etc. For example, if the digital file 20 is an audio or video file, the encrypted data 25 may specify that the file 20 has a limited number of playbacks before an end-user is required to pay more royalty fees via the clearinghouse 70. The encrypted data 25 can also specify output quality information and can provide such information to the output module 37 or the output device 50 for execution. For example, the output quality information could define the color balance for an image file, the print quality for a text file or document, or the sampling rate for an audio or video file.

### D. DIGITAL CONTENT ROYALTY MANAGEMENT SYSTEM WITH INTERMEDIARY

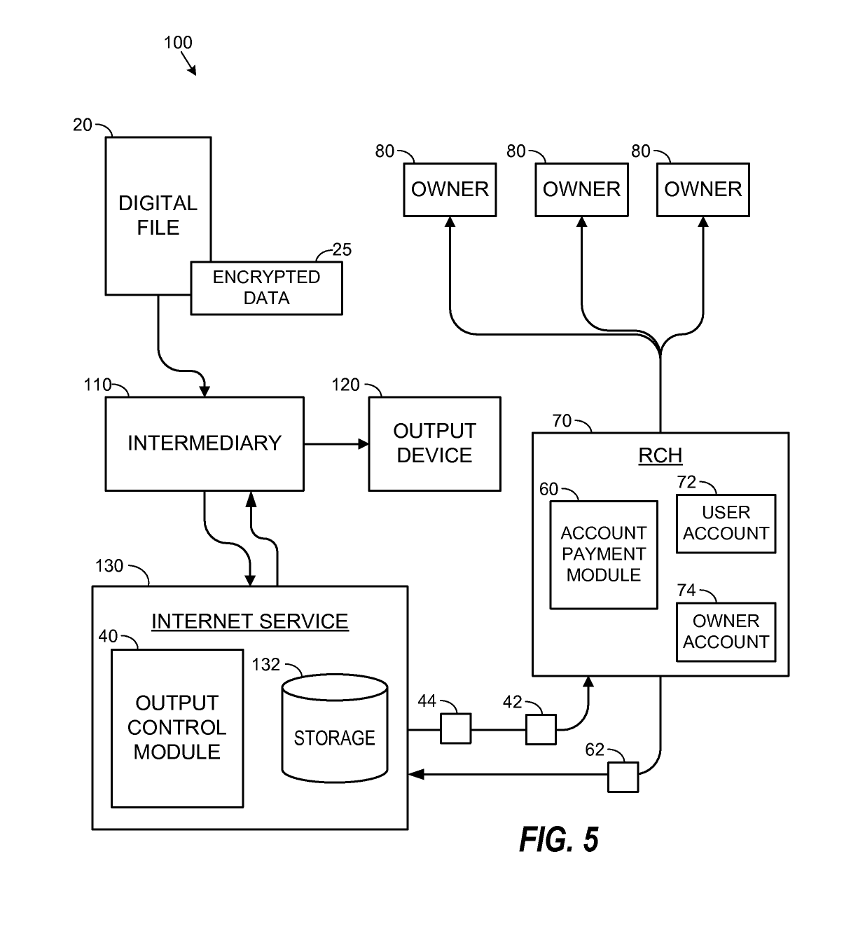

FIG. 5 shows an alternative arrangement to having an output control module 40 installed on a user device 30 as in FIG. 1. In the system 100 of FIG. 5, the output control module 40 resides on a remote server of an Internet service 130. When an intermediary 110 (e.g., photo-lab, copy center, or the like) processes a digital file 20 with encrypted data 25, the intermediary 110 can automatically access the output control module 40 via the Internet service 130 to be able to output the file 20. For example, the digital file 20 may be an image with encrypted data 25 that an end-user sends to an on-line photo lab as the intermediary 110 for printing on an output device 120. Before the file 20 can be output, the intermediary 110 accesses the output control module 40 residing on the Internet server 130. From this point, processing and output of the file 20 can follow in the same fashion discussed previously with respect to FIGS. 1 and 2 in which payment, access, and usage information are exchanged.

### E. EXAMPLES

With an understanding of the system shown either as 10 or 100 for digital content royalty management provided above, discussion now turns to a number of examples in which the disclosed system can be used.

### (1) Image File for Home Reproduction

In an example of the system 10 as embodied in FIG. 1, a professional photographer (as the owner 80) can control the output (copies, prints, etc.) of their copyrighted image files 20 and obtain royalties when a customer outputs the copyrighted image file 20 on a computer at home. The same process for controlling the output of a photographer's image file can also be used in other areas of digital file distribution and reproduction, such as reprints of magazine articles or book sections, distribution of audio and video files, etc.

In this example, the photographer 80 captures a digital image 20 and embeds copyright, size and print quality parameters (i.e., usage controls), and royalty information (i.e., usage rates) in the image file 20 using encrypted data 25 that cannot be removed and cannot be decoded without proper access. The photographer 80 then distributes the image file 20 to customers without necessarily requiring a purchase or a subscription.

A customer using a computer (as the user device 30) and a printer (as the output device 50) eventually attempts to print the image file 20 and finds that the file 20 cannot be output without proper royalty payment. In particular, the encrypted data 25 makes the image file 20 unreadable by the ordinary output functions of existing software on the end-user's computer 30 so that the output control module 40 must instead be used to access and output the image file 20.

Enabled by the output control module 40, the customer's computer 30 prompts the customer for charge-back information using a user interface. After the customer inputs an existing account number or new financial information into the interface, the computer 30 connects to the account payment module 60 installed on a remote server via the Internet and sends the charge-back information in a request 42 to the module 60. In turn, the account payment module 60 validates the charge-back information in the request 42 and sends back a validation 62 to unlock the image file 20 with the output control module 40. Of course, as discussed previously, the output control module 40 could determine that a previously received validation 62 is already associated with the digital file 20 allowing for its output. In addition, the output control module 40 could obtain the charge-back information from storage on the computer rather than interfacing directly with the user.

With the image file 20 unlocked, the customer can print the file 20 as allowed. The required size, print quality, color balance, or other parameters (i.e., usage controls) of the image's output may be gathered from the encrypted data 25 to ensure that the image file 20 is output in a manner consistent with photographer's pre-defined standards. The final output quality may, of course, be dependent on the capabilities of the printer 50. In any event, the output control module 40 may be capable of customizing its instructions to the printer 50 depending on the model, ink colors, type of paper, resolution, etc. so that the final print matches the photographer's intentions as near as possible given the limitations of the printer 50.

After output, the output control module 40 records the usage information describing the type, form, quantity, etc. of the print made and sends this usage information 44 back to the account payment module 60. When received, the account payment module 60 charges the customer's account or credit card 72 for the correct amount of royalties and credits the photographer's account 74 for the amount of royalties collected from customer.

### (2) Image File for Reproduction at Intermediary

In an example of the system 100 as embodied in FIG. 5, a professional photographer 80 can control the output of a copyrighted image 20 and obtain royalties when a customer reproduces the copyrighted image 20 at a print lab, Internet Service, print kiosk, or other intermediary 110. Again, the photographer 80 captures a digital image 20 and embeds copyright, size and print quality parameters, and royalty information in the image file 20. When the customer takes or uploads image file 20 to a photo-lab, an Internet print service, a print kiosk or other intermediary 110, the intermediary 110 determines that the file 20 is restricted by the encrypted data 25 and informs the customer that the image 20 is copyrighted and that per-print royalties will be added to the printing service. Before proceeding, the intermediary 110 needs a valid account with the royalty clearinghouse 70 in order to output the image file 20. The intermediary 110 can use the customer's charge-back information (e.g., credit card) or existing account or may have their own account with the clearinghouse 70. In most cases, the intermediary 110 may have a running account with the clearinghouse 70 that can be debited for royalties associated with any volume of printing performed.

When the intermediary 110 attempts to output the file 20, it sends an output request via the output control module 40 to the account payment module 60, which confirms that the intermediary 110 or the customer has a valid account. The account payment module 60 returns verification to the intermediary 110 via the output control module 40 permitting output, and the intermediary 110 then outputs the image file 20 as requested by the customer. Again, the required size, print quality, and color balance for the image 20 can be gathered from the encrypted data 25 so the output is consistent with photographer's standards. Finally, the output control module 40 sends the usage information back to the account payment module 60, which in turn charges the intermediary's or customer's account 72 for the correct amount of royalties and credits photographer's account 74.

### (3) Text or Portable Document Format Files for Home Reproduction

In another example of the system 10 as embodied in FIG. 1, an author or copyright owner 80 can create a document 20 (e.g., text or PDF file) with encrypted data 25 and can freely distribute the document 20. When a customer tries to output (e.g., copy, display, print, etc.) the document 20, the customer's computer 30 prompts the customer for charge-back information and sends the charge-back information in a request 42 via the Internet for validation by the account payment module 60. After validation, the account payment module 60 sends a validation 62 to the customer's computer 30 to unlock the document 20 with output control module 40. The customer then outputs (e.g., copies, displays, prints, etc.) the document 20, and any size and print quality, or other parameters gathered from the encrypted data 25 can control how the document 20 is ultimately output. Finally, the output control module 40 sends the usage information 44 back to the account payment module 60, which charges the customer's account 72 and credits the author's or copyright owner's account 74 to complete the transaction.

### (4) Text or Portable Document Format File for Reproduction at an Intermediary

In another example of the system 100 as embodied in FIG. 5, an author or copyright owner 80 can control output a copyrighted document 20 and to obtain royalties when a customer reproduces the document 20 at a copy center or other intermediary 110. For example, a customer may take or upload the document 20 to a copy center as an intermediary 110. From this point, outputting of the document 20, handling payment, access, and usage information, and processing credits and debits of accounts 72 and 74 can then proceed according to the same processes discussed previously with respect to image files.

### (5) Audio or Video File for Home Reproduction

In a final example of the system 10 as embodied in FIG. 1, a content creator 80 (e.g., a musician or a producer) can create an audio or video file 20 and can embed copyright, sampling rate, playback quality, and royalty formation in the audio or video file 20 using encrypted data 25 that cannot be removed and cannot be decoded without proper payment. The content creator 80 can then distribute the audio or video file 20 freely to customers without requiring purchase or a subscription.

When the customer tries to output (e.g., copy, play, burn, etc.) the file 20 with a computer, a music player, or the like, the output control module 40 restricts its output without proper royalty payment and access. The customer's computer, music player, etc. prompts the customer for charge-back information or obtains pre-stored charge-back information from storage 34 and sends this charge-back information in a request 42 to the account payment module 60. The account payment module 60 validates the charge-back information in the request 42 and returns a validation 62 to the output control module 40 to unlock the output of the file 20. In turn, the customer outputs the file 20, and the required sampling rate and playback quality can be gathered from the encrypted data 25 to control the final output according to the pre-defined standards. Finally, the output control module 40 sends the usage information 44 back to the account payment module 60, which in turn charges customer's account 72 and credits the content creator's account 74 for the amount of the royalties collected from customer.

### (6) Additional Examples

In one additional example, videos or songs may be available for live streaming from an Internet server at no charge to an end-use, and therefore, freely distributed. The end-user may also download the file without charge to their computer. If the end-user attempts to play the video or song other their computer, however, the output control module 40 and other components of the disclosed system could be used to charge the end-user for playing the video or song on their home computer. Royalties could be paid to the copyright owner 80 or to the provider of the Internet server.

In another example, a school, company or other institution may have a bulk account at the clearinghouse 70. In this case, an end-user at the institution may merely need to input an authorized user ID and password to allow the end-user to output digital files, while an output control module allows the output and reports the output to the clearinghouse for handling.

In yet another example, an end-user may incorporate a copyrighted photo, song, or the like on a website. The actual file for that photo or song will be stored on storage associated with a server having the webpage of the website. When an Internet user accesses the website and views the photo or listens to the song on the website, then conventional Internet software for tracking hits to a webpage could collect statistics of that use of the copyrighted content on the webpage. In turn, these collected statistics can be communicated to the output control module to report the use to the account payment module at the clearinghouse so royalty payments could be changed to the website's account at the clearing house and sent to the copyright owner.

### (7) Summary of Examples

As the above examples show, a copyright owner 80 can freely distribute a digital file 20 with encrypted data 25 without requiring an end-user to purchase the file 20 or have a subscription to a particular service. To account for the file's use, the end-user instead pays royalties for outputting the file 20 when and how they choose to output the file 20 according to an accounting (royalty) arrangement, which may be different for certain types of media and may be designed according to the copyright owner's royalty schedule. For example, a customer can download or receive a song without purchasing the song at the time and without having a subscription to an online music service. In this way, end-users can freely download, trade, copy, or distribute the song wherever and whenever he wants.

When the end-user wants to play the song on a specific mp3 player, however, he may have to pay a one-time royalty to unlock the song on that device. After unlocking the song, the end-user could then play the song on that device according to a pre-defined accounting (royalty) arrangement. In general, the accounting arrangement may require the end-user to pay a royalty for each time the end-user either plays the song, may allow unlimited playing of the song on the end-user's mp3 player, may allow a limited number of plays until another royalty is due, or may use any other arrangement as disclosed herein. If the end-user wants to play the song on a different device, or if his friend who copied the song from him wants to play the song on a different device, that additional device would need to be “unlocked” to play the song by satisfying an accounting requirement with charge-back information for the song on the additional device.

Should the end-user choose not to play the song anymore, they can do so without regret because they did not pay a purchase price for the song. Likewise, the end-user can obtain a new copy of the song if the end-user loses an existing copy of the song without having to make a payment. In addition, the end-user can freely send the song at no cost to someone else without duplicating it. The end-user may even be able to duplicate the song and send it to someone at no cost should the copyright owner allow such activities. In this instance, the recipient will have a copy of the song and will have to make royalty payments to play the song.

As the examples indicate, the disclosed systems 10/100 simplify distribution of digital files 20 and make the digital files 20 much more portable while at the same time secure. In addition, associating the encrypted data 25 with the digital file 20 and restricting output of the file 20 with the output control module 40 can prevent end-users from making illegitimate output of the digital file 20 without proper payment. Furthermore, copyright owners 80 (photographers, authors, publishers, musicians, producers, etc.) can control the reproduction quality of the output made by the end-user based on pre-defined parameters in the encrypted data 25. Also, copyright owners 80 can be fairly compensated for the quantity of copies that are made or the number of times the work is output or played back. Finally, the disclosed system 100 of FIG. 5 relieves the concern of intermediaries 110, such as imaging labs, copy centers, and on-line music/video distributors, that they may be inadvertently making illegal copies of copyrighted works because the encrypted data 25 can prevent them from doing so without proper royalty payments to the owner 80.

### F. ALTERNATIVE DETAILS

Given the description of the systems 10/100 and the previous examples, discussion now turns to various alternatives to the components of the systems 10/100.

### (1) User Device/Output Device

As shown in FIG. 1, the user device 30 and the output device 50 can be independent components. For example, the user device 30 can be a computer, and the output device 50 can be a printer, a scanner, a video system, an audio system, music playing software, a CD burner, document viewing software, etc. Alternatively, the user device 30 and output device 50 may be combined together and can be a personal music player, a copier, etc. These and other alternatives will be evident to one skilled in the art with the benefit of the present disclosure.

### (2) Output Control Module

As shown in FIG. 1, the output control module 40 runs on the user device 30. In general, the output control module 40 can be software, hardware, or firmware on the user device 30, the output device 50, or a combination of these. For example, the output control module 40 can be a software “plug-in” that the end-user downloads from the Internet and installs on the user device 30 so that existing software (e.g., a media player) on the user device 30 will be able to access, processes, and output digital files 20 having the encrypted data 25 restricting output of the files 20. For instance, this plug-in could hack in to applications to snoop when particular applications are being called to ensure that if registered copyrighted material is being accessed, the output control module 40 is called before the application is allowed to continue.

Alternatively, the output control module 40 can be included as part of software running on the user device 30 that is used to copy or output digital files 20. With the output control module 40 being software-based, only certain types of software may be able to read the special file format associated with the digital file 20, interpret the file's encrypted data 25, and feed the image, text, or other usage information to a printer, DVD player, MP3 player, or other output device 50.

In another alternative, the output control module 40 can be stored as firmware on the user device 30 or output device 50, or it can be a hardware component installed between the user device 30 or other digital storage device where the digital file 20 is stored and the final output device 50. If the output control module 40 is hardware or firmware-based, then its gateway capability can be native to the output device 50 (e.g., printer, DVD player, or MP3 player) and independent of the software driving the output device 50. Finally, the output control module 40 can be software running on or a hardware component built exclusively into the final output device 50. With the benefit of the present disclosure, one skilled in the art will appreciate that the output control module 40 can be implemented according to these and other alternatives.

### (3) Account Payment Module

The account payment module 60 can run on a server of the clearinghouse 70 or other remote manager and can be implemented using hardware, software, and combination thereof. The account payment module 60 in general requires an Internet or other network type of connection to receive charge-back information in a request 42, to receive usage information 44, and to send the validation 62. Therefore, it will be appreciated that the clearinghouse 70 can include servers, communication interfaces, and storage systems, each of which is not discussed in detail. Information can be communicated between the output control module 40 and the account payment module 60 via the Internet or other communication network using any number of available protocols and formats known and used in the art. These and other possibilities will be evident to one skilled in the art with the benefit of the present disclosure. The system can use pre-existing accounts such as iTunes, Paypal, etc. The system can also utilize systems that can accumulate micropayments, i.e., less than one cent. The system can use a system that handles all forms of currency or other forms of accounting, such points, credits, hits, or the like.

### (4) Clearinghouse

With respect to the royalty clearinghouse 70, digital content creators (e.g., photographers, authors, musicians, producers) may register and pay an annual fee to maintain an active account 74 capable of receiving royalty payments. Intermediaries 110 of FIG. 5 such as print labs, kiosk owners, copy centers, and manufacturers of DVD/MP3 players may also register and pay an annual fee to maintain an active account enabling them to output digital files, collect royalties, and credit the copyright owners with collected royalties. Finally, end-users may similarly register and pay an annual fee to maintain an active account 72, or they may submit charge-back information directly with a credit card for each restricted digital file 20. Again, the disclosed system 10/100 could also use any pre-existing system, such as the American Society of Composers, Authors, and Publishers (ASCAP) or the like, to handle payments or other accounting items.

### (5) Encrypted Data

As noted above, the output control module 40 decodes encrypted data 25 associated with a digital file 20 and acts as a gateway for outputting the digital file 20 based on the information decoded. The encrypted data 25 can take a number of forms. For example, the encrypted data 25 may be firmware-based so copyright and other information can be embedded in a digital file 20 at the moment of capture. Alternatively, the encrypted data 25 may be software-based so copyright and other information can be embedded in a digital file 20 after all editing, retouching or other modifications are complete. In addition to use of the encrypted data 25, the digital file 20 can use a unique and secure file format for the disclosed system 10. For example, the file format can cover unique and secure formats similar to Joint Photographic Experts Group (JPEG), Tagged Image File Format (TIFF), Portable Document Format (PDF), Moving Picture Experts Group Audio Layer 3 (MP3), etc. but that block the capabilities of ordinary software and hardware to process or output file's with such formats unless permitted to do so according to the techniques disclosed herein.

As discussed above, the output control module 40 in processing the encrypted data 25 decodes the data 25 and uses the decoded data 25 to obtain charge-back information and forward the charge-back information in an access request to the account payment module 60. After providing the charge-back information (e.g., a credit card or financial account number) in the request 42 to the account payment module 60 and receiving the validation 62, the output control module 40 unlocks the digital file 20 for output. This act of unlocking the digital file 20 can use a number of available techniques for restricting and providing access to the digital file 20. For example, the validation 62 and subsequent unlocking of the file 20 can function in a manner substantially similar to existing techniques for processing software that has been downloaded on a device for trial use and that requires a subsequent purchase before the full capabilities of the software are enabled. Thus, the validation 62 can include a key or code communicated to the output control module 40 that permits output software to access and process the file 20. This access may or may not expire within a given length of time once provided.

Alternatively, the digital file 20 may actually be an incomplete version of the file 20, and only the complete version of the file 20 is downloaded to the user device 30 from a remote source after charge-back information has been received by the account payment module 60. In this instance, the validation 62 may include information for the user device 30 to connect to a remote source and obtain the complete file 20 or may be portion of the digital file 20 to make it complete for outputting.

In another example to unlock the file 20, the output control module 40 may use a key or algorithm (either from the validation 62 or elsewhere) to convert the data in the file 20 from a secure, encrypted, or unreadable format to an accessible format that can be processed by conventional software on the user device 30. In yet another example, the output control module 40 may work in conjunction with output processing software running on the user's device 30 to restrict processing and output of the file 20 unless and until access is allowed by the module 40. In this context, the output processing software can be part of or separate from the module 40. In any event, the module 40 may allow access to the file 20 upon receipt of a key or the like in the validation 62 from the account payment module 60.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A digital content management apparatus, comprising:
a user interface;
storage for digital content, the digital content being freely distributed and having encrypted data, the encrypted data having a plurality of usage controls controlling use of the digital content; and
a control module in communication with the user interface and the storage, the control module configured to:
restrict use of the portable digital content unless an accounting requirement is satisfied for use of the digital content,
determine that the accounting requirement is satisfied,
decode the usage controls in the encrypted data,
obtain a selection of at least one of the usage controls, and
enable, based on the satisfied accounting requirement, use of the portable digital content in accordance with the at least one selected usage control.

2. The apparatus of claim 1, wherein the encrypted data comprises a watermark having first data steganographically embedded within second data of the digital content.

3. The apparatus of claim 1, wherein the restricted use of the digital content comprises a restriction on one or more of acts protected by copyright.

4. The apparatus of claim 1, wherein to satisfy the accounting requirement, the control module is configured to obtain charge-back information indicating how to charge use of the digital content to the user.

5. The apparatus of claim 4, wherein the control module obtains the charge-back information from the user via the user interface.

6. The apparatus of claim 4, wherein the control module obtains the charge-back information from the storage.

7. The apparatus of claim 1, further comprising a communication interface in communication with the control module.

8. The apparatus of claim 7, wherein to satisfy the accounting requirement, the control module is configured to communicate charge-back information to a remote manager via the communication interface, the charge-back information indicating how to charge use of the digital content to the user.

9. The apparatus of claim 8, wherein the control module obtains connection information for the remote manager from the encrypted data.

10. The apparatus of claim 8, wherein to satisfy the accounting requirement, the control module is configured to receive permission from the remote manager to use the digital content.

11. The apparatus of claim 7, wherein the control module stores information descriptive of the use of the digital content in storage for communicating to a remote manager via the communication interface.

12. The apparatus of claim 1, wherein to satisfy the accounting requirement, the control module is configured to verify a predefined charge-back arrangement between the user and a remote manager.

13. The apparatus of claim 1, wherein the usage controls comprise one or more of: a parameter to control use, an output parameter, a quality, a color, a size, a color balance, a sampling rate, a duration of use, and a number of instances of use for the digital content.

14. The apparatus of claim 1, wherein the encrypted data comprises a plurality of usage rates for use of the digital content according to the usage controls.

15. The apparatus of claim 14, wherein to obtain the selection, the control module is configured to:
communicate information about the usage controls and the usage rates to the user via the user interface; and
receive the selection from the user interface based on the communicated information.

16. A digital content management method, comprising:
determining a plurality of usage controls for digital content by decoding encrypted data associated with the digital content, the usage controls controlling use of the digital content;
restricting use of the digital content at a destination unless an accounting requirement is satisfied for use of the digital content;
determining that the accounting requirement is satisfied at the destination;
obtaining a selection of at least one of the usage controls at the destination; and
enabling, based on the satisfied accounting requirement, use of the digital content in accordance with the at least one selected usage control.

17. A digital content royalty management apparatus, comprising:
a communication interface;
storage for account information; and
an account module in communication with the communication interface and the storage, the account module being configured to:
receive charge-back information for a user device to use digital content, the digital content freely distributed and having a plurality of usage options, each of the usage controls controlling use of the digital content and being associated with a usage rate,
determine that the charge-back information satisfies an accounting requirement that must be satisfied for use of the digital content, and
return, based on the satisfied accounting requirement, permission for the user device to use the digital content.

18. The apparatus of claim 17, wherein the account module is configured to:
receive usage information from the user device, the usage information being descriptive of the use of the digital content controlled by the usage controls and of the usage rates associated with the use; and
update first and second accounts with the usage information received from the user device, the first account associated with the charge-back information of the user device, the second account associated with an owner of the digital content.

19. The apparatus of claim 17, further comprising an encoding module being configured to:
encode the usage controls in the encrypted data to control use of the digital content;
encode the usage rates associated with the usage controls; and
permit free distribution of the digital content with the encrypted data.

20. A digital content royalty management method, comprising:
receiving charge-back information from a user device to use digital content, the digital content freely distributed and having a plurality of usage controls, each of the usage controls controlling use of the digital content and being associated with a usage rate;
determining that the charge-back information satisfies an accounting requirement that must be satisfied for use of the digital content; and
returning, based on the satisfied accounting requirement, permission for the user device to use the digital content.

21. The method of claim 20, further comprising:
receiving usage information from the user device, the usage information being descriptive of the use of the digital content controlled by the usage controls and of the usage rates associated with the use; and
updating first and second accounts with the usage information received from the user device, the first account associated with the charge-back information of the user device, the second account associated with an owner of the digital content.

22. The method of claim 20, further comprising associating the encrypted data with the digital content by—
encoding the usage controls in the encrypted data to control use of the digital content;
encoding the usage rates associated with the usage controls; and
permitting free distribution of the digital content with the encrypted data.
